(19) United States
(12) Patent Application Publication
(10) Pub. No.: US 2026/0184261 A1
(43) Pub. Date: Jul. 2, 2026

(54) DISPLAY MIRROR TILTING MESSAGING AND FEEDBACK

(71) Applicant: Gentex Corporation, Zeeland, MI (US)

(72) Inventors: Eric S. Lundy, Holland, MI (US); Richard T. Fish, JR., Hudsonville, MI (US); David M. Falb, Grand Rapids, MI (US)

(21) Appl. No.: 19/431,853

(22) Filed: Dec. 23, 2025

Related U.S. Application Data
(60) Provisional application No. 63/740,705, filed on Dec. 31, 2024.

(51) Int. Cl. B60R 1/26; B60R 1/04

(52) U.S. Cl. CPC B60R 1/26; B60R 1/04; B60R 2300/10; B60R 2300/20

(57) ABSTRACT

A display mirror assembly for a vehicle includes an electro-optic element with a partially reflective, partially transmissive front substrate that has a rounded peripheral edge and a rear substrate. The front substrate defines first and second surfaces and the rear substrate that defines third and fourth surfaces. An electro-optic medium is disposed between the front and rear substrates. A mounting member is operably coupled to the vehicle and the electro-optic element. An imager is configured to capture image data outside the vehicle. A display module is disposed adjacent to the rear substrate and configured to display the image data captured by the imager. A control circuit is configured to control and power the electro-optic element and the display module. A sensor is operably coupled with the electro-optic element and configured to monitor rotation of the electro-optic element between on-axis and off-axis positions and also activate or deactivate the display module.

### CROSS-REFERENCE TO RELATED APPLICATION

This application claims priority to and the benefit under 35 U.S.C. § 119(e) of U.S. Provisional Application No. 63/740,705, filed on Dec. 31, 2024, entitled “DISPLAY MIRROR TILTING MESSAGING AND FEEDBACK,” the disclosure of which is hereby incorporated herein by reference in its entirety.

### FIELD OF THE DISCLOSURE

The present disclosure generally relates to a rearview device system, and more particularly, a display mirror assembly having a partially reflective, partially transmissive element and a display behind the reflective element.

### SUMMARY OF THE DISCLOSURE

According to one aspect of the present disclosure, a display mirror assembly for a vehicle includes an electro-optic element that includes a partially reflective, partially transmissive front substrate that has a rounded peripheral edge. The front substrate defines a first surface and a second surface. The electro-optic element also includes a rear substrate that defines a third surface and a fourth surface and an electro-optic medium disposed between the front substrate and the rear substrate. A mounting member is operably coupled to the vehicle and to the electro-optic element. An imager is configured to capture image data outside the vehicle. A display module is disposed adjacent to the rear substrate and configured to display the image data captured by the imager. A control circuit is configured to control and power the electro-optic element and the display module. A sensor is operably coupled with the electro-optic element and configured to monitor rotation of the electro-optic element between on-axis and off-axis positions and also activate or deactivate the display module.

According to another aspect of the present disclosure, a display mirror assembly for a vehicle includes a housing that is free of an axis-changing toggle flipper and an electro-optic element that is operable between a cleared state and a darkened state. The electro-optic element is supported within the housing. A display proximate the electro-optic element is at least partially visible through the electro-optic element. The housing is rotatable by a user to an off-axis position which changes an activation state of the display. The housing is also rotatable by the user to an on-axis position which also changes the activation state of the display.

According to another aspect of the present disclosure, a display mirror assembly for a vehicle includes an electro-optic element and a mounting member that is operably coupled to the vehicle and to the electro-optic element. An imager is configured to capture image data outside the vehicle. A signal representative of received light is communicated from the imager to a control circuit and the image data captured by the imager is evaluated by the control circuit to determine likely glare on the electro-optic element. A display module is disposed adjacent to a rear substrate and is configured to display the image data captured by the imager. The control circuit is configured to control and power the electro-optic element and the display module. A sensor is operably coupled with the electro-optic element. The control circuit is configured to monitor vertical rotation of the electro-optic element between an on-axis position where the display module is activated and an off-axis position where the display module is deactivated.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top front perspective view of a display mirror assembly for a vehicle;

FIG. 2 is a bottom front perspective view of the display mirror assembly of FIG. 1;

FIG. 3 is a side elevation view of the display mirror assembly of FIG. 1;

FIG. 4 is a partially exploded top perspective view of the display mirror assembly of FIG. 1;

FIG. 5 is a partially exploded top perspective view of the display mirror assembly of FIG. 1;

FIG. 6 is an exploded top perspective view of the display mirror assembly of FIG. 1

FIG. 7 is an enlarged partial side cross-sectional view of the display mirror assembly of FIG. 1;

FIG. 8 is a side elevation view of the display mirror assembly of FIG. 1;

FIG. 9 is a side elevation view of the display mirror assembly of FIG. 1;

FIG. 10 is a side elevational cross-sectional view of a display mirror assembly the present disclosure in a display state;

FIG. 11 is a side elevational cross-sectional view of a display mirror assembly of the present disclosure in a reflective state;

FIG. 12 is a front elevational view of a display mirror assembly of the present disclosure, shown reflecting a rear view of a vehicle; and

FIG. 13 is a front elevational view of a display mirror assembly of the present disclosure, shown illustrating instructions to activate a display.

### DETAILED DESCRIPTION

The present illustrated embodiments reside primarily in combinations of method steps and apparatus components related to a display mirror. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

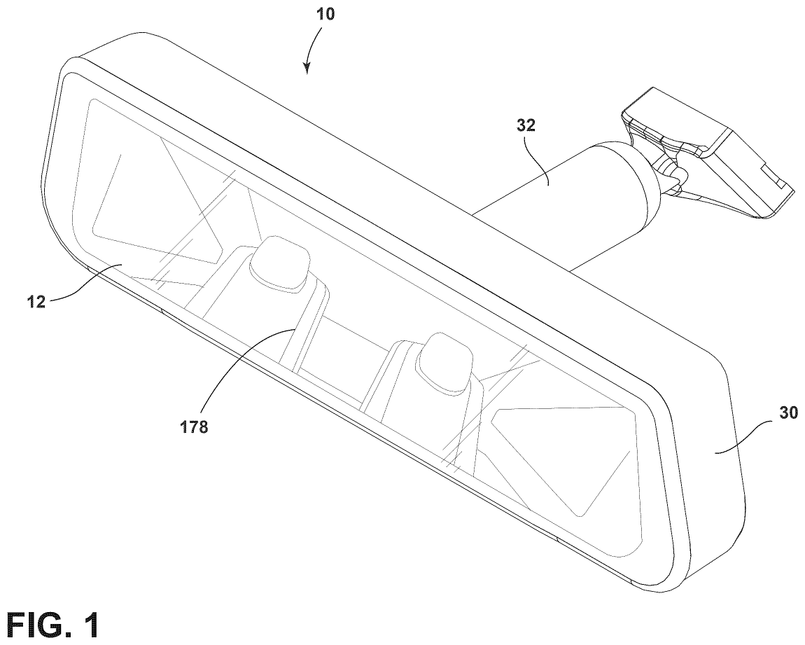

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer of the display mirror, and the term “rear” shall refer to the surface of the element further from the intended viewer of the display mirror. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

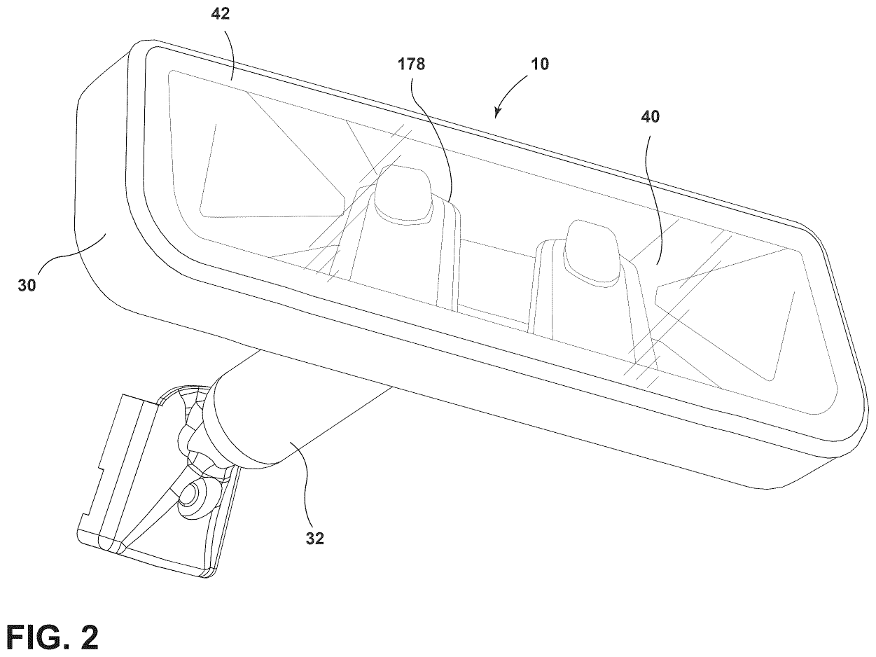

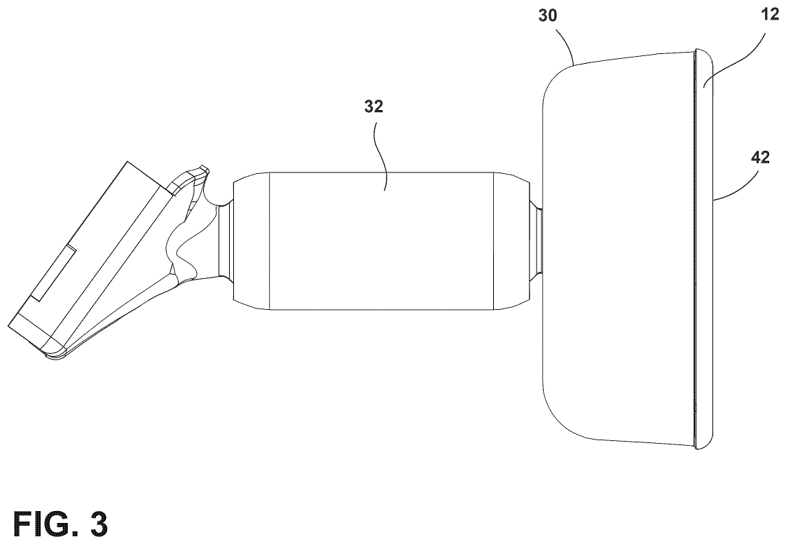

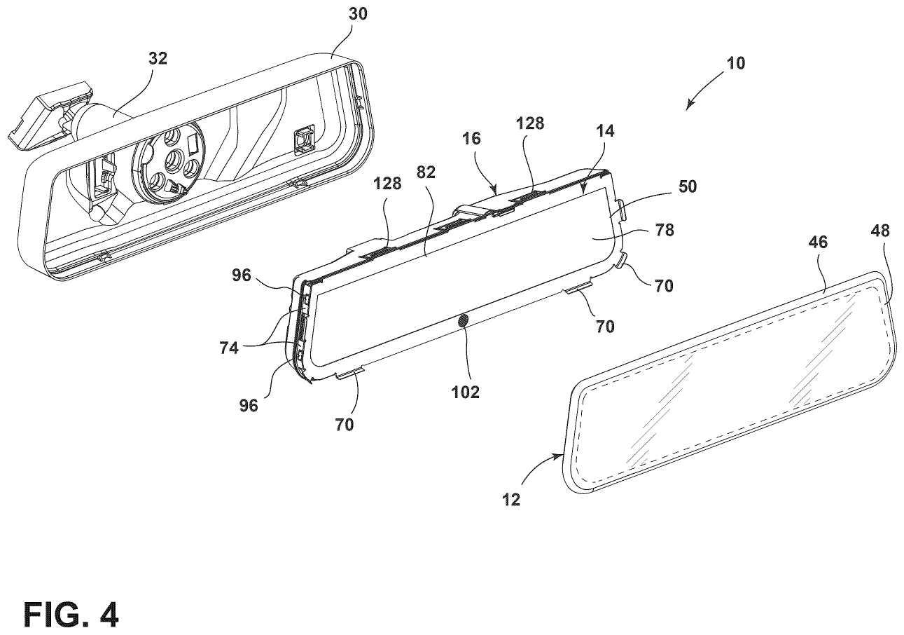

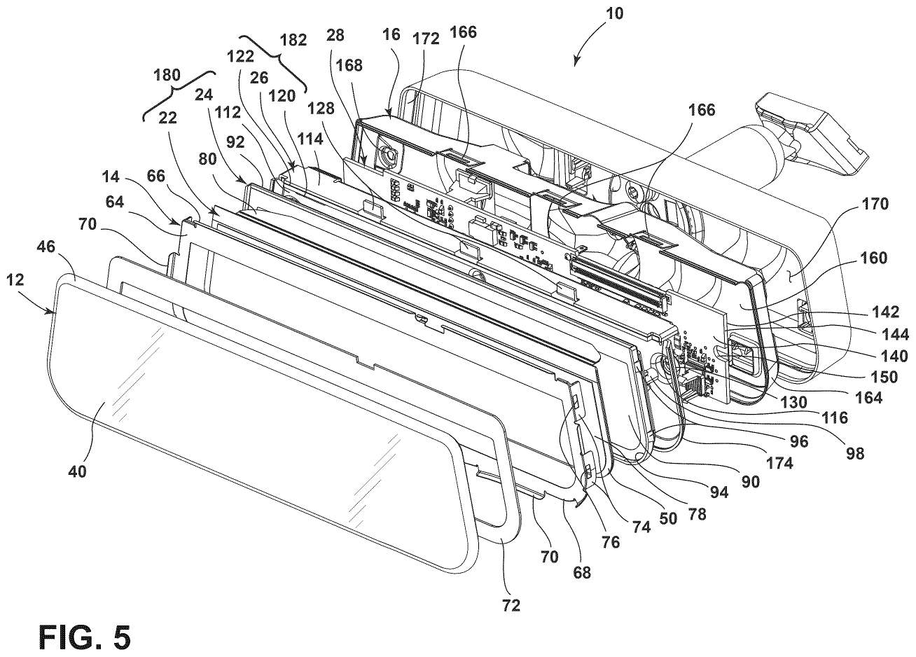

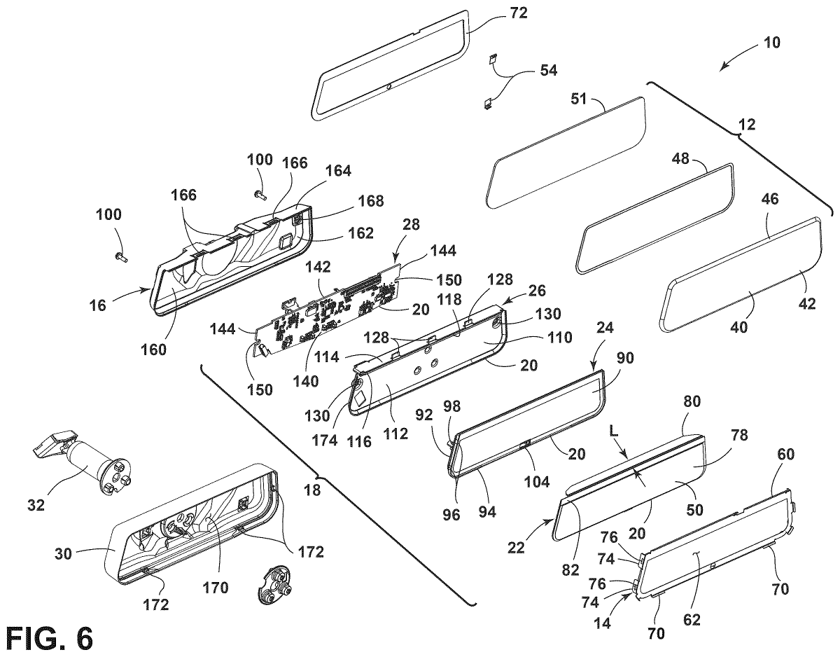

Referring now to FIGS. 1-3, reference numeral 10 generally designates a display mirror assembly for a vehicle. The display mirror assembly 10 includes a partially reflective, partially transmissive element 12 (also referred to as a “glass element” herein) and a display module 18 (FIG. 6) that is viewed through the partially reflective, partially transmissive element 12. As shown in FIG. 4, the display mirror assembly 10 further includes a front shield 14 and a rear shield 16 which shield and support the partially reflective, partially transmissive element 12 and the display module 18 (FIG. 6). As shown in FIGS. 5 and 6, the display module 18 generally includes several components 20, including a display 22, an optic block 24, a heat sink 26, and a primary printed circuit board (PCB) 28. A housing 30 at least partially receives the front shield 14, the display module 18, and the rear shield 16, and includes a mounting member 32 extending rearwardly therefrom. The mounting member 32 is adapted for mounting on a windshield of a vehicle. The housing may be configured to be part of the outer profile of the partially reflective, partially transmissive element.

Referring generally to FIGS. 1-5, the display mirror assembly 10 has a viewing area 40 disposed on a front surface of a front substrate 42 of the glass element 12. The viewing area 40 may be a rectangular shape, a trapezoidal shape, or any custom contoured shape desired for aesthetic reasons.

Referring to FIG. 4, the display mirror assembly 10 for a vehicle is shown, with the components partially exploded. The display mirror assembly 10 includes the glass element 12, the front shield 14 and the rear shield 16 encapsulating the display module 18, the rear housing 30, and the mounting member 32. As shown in FIGS. 4-6, the front shield 14, the rear shield 16, and components of the display module 18 include various retaining features to operably connect the several components of the display module 18 with the front shield 14, the rear shield 16 and each other, and to provide support to the display module 18. Specifically, the front shield 14 includes retaining features to operably connect the front shield 14 to the display module 18, and the rear shield 16 has retaining features to operably connect the rear shield 16 to the display module 18. The retaining features generally include snap fit connections, tab and slot connections, screw connections, and other known retaining features. Some or all of the retaining features may also be strengthened by the addition of adhesive compounds. Certain non-limiting illustrative examples of retaining features are described in detail herein.

The display mirror assembly 10 will hereafter be described in greater detail, beginning with the elements closest to the intended viewer, and extending rearwardly away from the viewer.

As shown in FIG. 4, the glass element 12 is generally planar, with an outer perimeter 46 and a border around the outer perimeter 46. The border may incorporate a peripheral concealing layer 48 or edge treatment, such as a chrome ring or other similar finish, to conceal a peripheral area of the front shield 14 and other elements located behind the glass element 12 in the display mirror assembly 10, including without limitation a seal on an electrochromic unit, an applique, foam adhesive, or pad printing. The border may extend from the outer perimeter 46 of the glass element 12 to an outer edge 50 of the display 22. Alternatively, the border may be narrower and not reach from the outer perimeter 46 to the outer edge 50 of the display 22 along at least some portions of the border. The outer perimeter 46 of the glass element 12 may also have a ground edge, a bezeled edge, or be frameless.

The glass element 12 may include an electro-optic element or include a prism-type construction. The prism-type construction generally includes one glass element 12 having a varying thickness from top to bottom. With an electro-optic element, the glass element 12 includes at least two glass substrates. For example, as illustrated in FIG. 6, the glass element 12 includes the front substrate 42, which defines a first surface and a second surface, as well as a rear substrate 51, which defines a third surface and a fourth surface. An electro-optic medium is disposed between the second surface of the front substrate 42 and the third surface of the rear substrate 51. The electro-optic medium generally includes at least one solvent, at least one anodic material, and at least one cathodic material. Typically, both of the anodic and cathodic materials are electroactive and at least one of them is electrochromic. The term “electroactive” may be defined herein as a material that undergoes a modification in its oxidation state upon exposure to a particular electrical potential difference. Additionally, it will be understood that the term “electrochromic” includes a material that exhibits a change in its extinction coefficient at one or more wavelengths upon exposure to a particular electrical potential difference. Electrochromic components, as described herein, include materials whose color or opacity are affected by electric current, such that when an electrical current is applied to the material, the color or opacity change from a first phase to a second phase.

The electrochromic component as disclosed herein may be a single-layer, single-phase component, multi-layer component, or multi-phase component, as described in U.S. Pat. No. 5,928,572 entitled “Electrochromic Layer And Devices Comprising Same,” U.S. Pat. No. 5,998,617 entitled “Electrochromic Compounds,” U.S. Pat. No. 6,020,987 entitled “Electrochromic Medium Capable Of Producing A Pre-selected Color,” U.S. Pat. No. 6,037,471 entitled “Electrochromic Compounds,” U.S. Pat. No. 6,141,137 entitled “Electrochromic Media For Producing A Pre-selected Color,” U.S. Pat. No. 6,241,916 entitled “Electrochromic System,”U.S. Pat. No. 6,193,912 entitled “Near Infrared-Absorbing Electrochromic Compounds And Devices Comprising Same,” U.S. Pat. No. 6,249,369 entitled “Coupled Electrochromic Compounds With Photostable Dication Oxidation States,” and U.S. Pat. No. 6,137,620 entitled “Electrochromic Media With Concentration Enhanced Stability, Process For The Preparation Thereof and Use In Electrochromic Devices”; U.S. Patent Application Publication No. 2002/0015214 A1 entitled “Electrochromic Device”; and International Patent Application Serial Nos. PCT/US98/05570 entitled “Electrochromic Polymeric Solid Films, Manufacturing Electrochromic Devices Using Such Solid Films, And Processes For Making Such Solid Films And Devices,” PCT/EP98/03862 entitled “Electrochromic Polymer System,” and PCT/US98/05570 entitled “Electrochromic Polymeric Solid Films, Manufacturing Electrochromic Devices Using Such Solid Films, And Processes For Making Such Solid Films And Devices,” which are herein incorporated by reference in their entirety. The glass element 12 may also be any other element having partially reflective, partially transmissive properties. To provide electric current to the glass element 12, electrical elements are provided on opposing sides of the glass element 12, to generate an electrical potential therebetween. A J-clip 54 is electrically engaged with each electrical element, and element wires extend from the J-clips 54 to the primary PCB 28.

Now referring to the embodiments illustrated in FIGS. 5 and 6, the front shield 14 and the rear shield 16 function to shield the display module 18 from radio frequency (RF) electromagnetic radiation and to provide support for the glass element 12 and the display module 18. The front shield 14 is formed from one or more materials which are suitable to block RF radiation, including without limitation steel, for example. As a non-limiting example, the front shield 14 can be formed from a stamped steel material which is about 0.2 mm thick to 1.0 mm thick. In addition to preventing electromagnetic radiated emissions, the front shield 14 and the rear shield 16 also protect the circuitry of the device from electromagnetic susceptibility (conduction).

With reference again to FIGS. 5 and 6, the front shield 14 is generally shaped in the form of a ring 60 having an opening 62 therethrough. The front shield 14 has a front side 64, rear side 66, and an outer surface 68 which is generally coextensive with the outer perimeter 46 of the glass element 12. The front shield 14 includes retaining features 70 extending forwardly therefrom, to mechanically engage the glass element 12. An adhesive, such as a foam adhesive 72, may also be used to secure the glass element 12 to the front shield 14. The front shield 14 further includes rearwardly directed tabs 74 to operably engage the rear shield 16 (or a component of the display module 18). The rearwardly directed tabs 74 further include holes 76 therethrough, to operably engage at least one component of the display module 18, such as the optic block 24.

As clearly illustrated in FIG. 6, the display module 18 is disposed behind the front shield 14, with the display 22 viewable through the opening 62 in the front shield 14. The components of the display module 18 are ordered, from the front shield 14 toward the rear shield 16, in the following order: the display 22, the optic block 24, the heat sink 26, and the primary PCB 28.

The display 22 is generally planar, with the outer edge 50 defining a front surface 78. The front surface 78 of the display 22 can be shaped to correspond to and fit within the shape of the viewing area 40 of the display mirror assembly 10. Alternatively, the display 22 may have a front surface 78 which fits within, but is not complementary to the viewing area 40, for example, where the front surface 78 of the display 22 is generally rectangular and the front substrate 42 of the glass element 12 has a contoured outer perimeter 46. The distance between the outer edge 50 of the display 22 and the outer perimeter 46 of the glass element 12 is about 9 mm or less along at least a portion of the outer edge 50. In one embodiment, the display 22 has a viewable front surface 78 area which is about 56% to about 70% of the viewing area 40 of the glass element 12.

The display 22 may be a liquid crystal display (LCD), a light-emitting diode (LED), an organic light-emitting diode (OLED), plasma, digital light processing (DLP), or other display technology. The display 22 further includes a flexible electrical connector 80 which is operably mechanically and electrically connected with the primary PCB 28. The flexible electrical connector 80 has a length L that is sufficient to extend over and wrap around the display module components between the display 22 and the primary PCB 28 and has a width which extends substantially along a top edge 82 of the display 22. Ends of the flexible electrical connector 80 may be chamfered to ease manufacturing. The flexible electrical connector 80, when operably coupled to the primary PCB 28, aids in securing the components along a top edge of the display module 18.

As shown in FIGS. 5 and 6, the optic block 24 includes a front side 90 which is facing the display 22, a rear side 92 which is facing the heat sink 26, and an outer perimeter 94. The optic block 24 further includes tabs 96 extending generally outwardly therefrom around at least a portion of the outer perimeter 94. In the illustrated embodiment, the tabs 96 extend from sides of the optic block 24. However, it is contemplated that the tabs 96 could be located anywhere along the periphery of the optic block 24. The tabs 96 are received through the holes 76 in the rearwardly directed tabs 74 of the front shield 14, to operably couple the optic block 24 with the front shield 14. The optic block 24 further includes at least one receiving element 98 for receiving a mechanical fastener on the rear side 92 thereof. The receiving elements 98 are adapted to engage mechanical fasteners 100 threaded through the rear shield 16 and the display module 18 components between the optic block 24 and the rear shield 16. In alternate embodiments, the tabs 96 for engaging the front shield 14, the screw-receiving elements 98, or both, could be provided on different components of the display module 18.

As shown in FIGS. 4 and 6, a glare sensor optic 102 is provided on the front side 90 of the optic block 24, in a location which receives light through the glass element 12, and which is not behind the display 22. The glare sensor optic 102 is snap-fit into a receiving aperture 104 in the optic block 24. The glare sensor optic 102 receives light from headlamps of a trailing vehicle, and measures information regarding the likely glare visible on the glass element 12 and communicates this information to the display mirror assembly 10 so that the display mirror assembly 10 can be optimized to allow viewing of the display 22 through the glass element 12. The glare sensor optic's 102 optical vertical/horizontal pattern is symmetrical, so that orientation of the glare sensor optic 102 is not significant as shown in its circular geometry. The glare sensor optic 102 could also have an asymmetrical vertical/horizontal light gathering pattern, in which case a keyed feature would be put into the lens to verify correct orientation in the display mirror assembly 10. The glare sensor optic 102 could also be packaged at least partially within the housing 30 of the display mirror assembly 10 and have a light guide which is configured to propagate light to the glare sensor optic 102. The glare sensor optic 102 could also be an imager on a rear portion of the vehicle, where a signal representative of the received light is communicated from the glare sensor optic 102 to the display mirror assembly 10.

With reference again to FIGS. 5 and 6, the heat sink 26 is disposed rearwardly from the optic block 24, and dissipates heat generated by the primary PCB 28 and other components of the display module 18. The heat sink 26 has a generally planar body 110 with a front side 112 and a top edge 114. A channel 116 extends along the top edge 114 of the heat sink 26, and defines a forward-facing opening 118. An edge lit PCB 120 and a gap filler or thermal interface material 122 are disposed partially within the channel 116, with the edge lit PCB 120 extending generally perpendicularly from the heat sink 26 in a forward direction, and having an operable side which is facing downward, away from the top edge 114. The edge lit PCB 120 includes a wiring adapted for electrical connection with the primary PCB 28, to permit electrical power and signals to be supplied to the edge lit PCB 120. The gap filler 122 could be a gap filler pad, a thermally conductive epoxy, or other material used to increase the heat transfer from the edge lit PCB 120 to the heat sink 26. A plurality of tabs 128 extend upwardly from the top edge 114 of the heat sink 26, for mechanical engagement with the rear shield 16.

The heat sink 26 also includes at least one hole 130 therethrough to receive a mechanical fastener 100 threaded from the rear shield 16 to the optic block 24. The receiving element 98 of the optic block 24 is optionally raised, to extend through the at least one hole 130 in the heat sink 26 and receive the mechanical fastener 100. The receiving element 98 of the optic block 24 may also aid in alignment of the components of the display module 18 during manufacturing and will provide additional reinforcement to the display module 18 in the interaction between components if it is raised. Moreover, the receiving element 98 both secures the components of the display module 18 together and aids in maintaining proper spacing of the components.

The primary PCB 28 operates to provide electrical power and control for the components of the display module 18 and for the glass element 12. As shown in FIGS. 5 and 6, the primary PCB 28 is generally planar, with a front side 140, a rear side 142, and side edges 144. The front side 140 faces the heat sink 26 and the rear side 142 faces the rear shield 16. Electrical components are generally oriented on both sides of the primary PCB 28. The primary PCB 28 includes an electrical connector for operable electrical engagement with the electrical element wires of the glass element 12, an electrical connector for operable electrical engagement with the flexible electrical connector 80, and an electrical connector for operable electrical engagement with the wiring harness. Additional functional elements that may be provided on the display mirror assembly 10 may also be electrically connected to the primary PCB 28, such as the glare sensor optic 102 and any other functional buttons or features of the display mirror assembly 10. The primary PCB 28 further includes side cutouts 150 along the side edges 144, to permit passage of the mechanical fasteners 100 used to secure the rear shield 16 to the components of the display module 18.

With reference again to FIGS. 4 and 5, the rear shield 16 also serves to encapsulate the display module 18, and further interlock the components of the display mirror assembly 10. The rear shield 16 functions to shield the display module 18 from RF radiated and conducted emissions. The rear shield 16 is formed from a material which is suitable to block such radiation and provide the desired support for the display mirror assembly 10, such as steel. As a non-limiting example, the rear shield 16 can be formed from stamped steel with a thickness of about 0.2 to 1 mm. It is also contemplated that a welded or die-formed rear shield 16 could be provided.

As shown in FIG. 6, the rear shield 16 includes a rear wall 160 having an outer perimeter 162, and a peripheral wall 164 extending forward from the rear wall 160 about at least a portion of the outer perimeter 162. The peripheral wall 164 has slots 166 therein, which correspond to the upstanding tabs 128 along the top edge 114 of the heat sink 26 and are operably mechanically engageable therewith. The rear shield 16 further includes at least one hole 168 there through to accommodate the mechanical fastener 100, where the mechanical fastener 100 extends through the rear shield 16 and into the components of the display module 18 to secure the rear shield 16 to the display module 18. The mechanical fastener 100 extends through the rear wall 160 of the rear shield 16, through the side cutouts 150 of the primary PCB 28, through the heat sink 26, and is secured to the screw-receiving element 98 on the rear side 92 of the optic block 24.

As shown in FIG. 6, the rear housing 30 includes a forwardly directed cavity 170, into which all or a portion of the front shield 14, rear shield 16, and the display module 18 supported therebetween are inserted. The rear housing 30 includes mechanically engaging features 172 which snap fit with corresponding engagement features 174 located on the peripheral wall 164 of the rear housing 30 or on a display module 18 component such as the heat sink 26. The mounting member 32 is operably engaged with the rear housing 30 in any known manner.

With respect to the following description, the display mirror assembly 10 is considered “on axis” when a line perpendicular to the plane of the glass element 12 extends toward the eyes of a viewer. Due to the display 22 being viewed through the glass element 12, any glare on the glass element 12 may interfere with the visibility of the display 22. When the display mirror assembly 10 is on axis and is being used during night time driving conditions, headlights from a trailing vehicle (i.e., a vehicle driving behind the vehicle with the display mirror assembly 10) can cause a glare which is visible to the driver. Traditional constructions have utilized an actuator device that is operably coupled to the display mirror assembly 10. The actuator device may be similar to the actuator device set forth in U.S. Pat. No. 10,739,591, which is hereby incorporated by reference in its entirety. When actuated, the actuator device moves at least the glass element 12 (and some times other components of the display mirror assembly 10) off axis (i.e., away from a direct line toward the driver's eyes). Typically, actuation of the actuator device tilts the glass element 12 upward, to move the mirror to an off-axis position. However, it should be appreciated that the actuator device could be configured to move the mirror in any direction with respect to the axis. These actuator devices could also be configured to move the display 22 upon activation and be configured to turn the display 22 on or off. Thus, when the actuator device was actuated to move the mirror off axis, the display 22 can be turned off. Typically, when the actuator device is actuated, the display mirror assembly 10 would rotate with the glass element 12 and the display 22, keeping a constant distance relationship to each other. When the actuator device was activated, the mounting member 32 and flipper plate would not move with respect to the rest of the vehicle. In the illustrated embodiment, the glass element 12 and the display 22 are rigidly affixed to each other and do not move independently of one another. Alternatively, the glass element 12 could be configured to move independently of the display 22. Additionally, to provide information to the viewer of the display mirror assembly 10, the display mirror assembly 10 may include information regarding the field of view 178, such as a partially transmissive graphic overlay or an image on the display 22 visible on the viewing area 40 when the display mirror assembly 10 is in use. As will be explained in further detail herein, the disclosed configuration allows for activation and deactivation of the display 22 by a user simply grasping the housing 30 of the display mirror assembly 10 and rotating the housing 30 upward or downward about a horizontal axis. This configuration eliminates the need for a flipper or toggle switch that extends from the housing 30 of the display mirror assembly 10 thereby providing a more streamlined and aesthetically appealing rearview device.

In order to construct the display mirror assembly 10 described herein, the J-clips 54 are installed on the glass element 12, and then element wires are soldered to the top portion of the J-clips 54. The glass element 12 is then secured to the front side 64 of the front shield 14, using the foam adhesive 72 and the forward retaining features 70 of the front shield 14. The front shield 14 is then inverted, with the glass element 12 facing downwardly on a protective surface.

A first subassembly 180 (FIG. 5), including the display 22 and optic block 24, is assembled by snap-fitting the glare sensor optic 102 into the receiving aperture 104 in the optic block 24, and adhering the display 22 to the optic block 24. The adhesion of the display 22 and optic block 24 may include coating the front side 90 of the optic block 24 with an adhesive and applying a release liner over the adhesive, wherein the release liner is easily removable from the adhesive. When it is time to assemble the display 22 and optic block 24, the release liner is removed, and the display 22 is positioned on the front side 112 of the optic block 24. To position the display 22, one edge of the display 22 is aligned in the appropriate location on the optic block 24, and then the display 22 is rotated into contact with the front side 90 of the optic block 24. The first subassembly 180 is placed in position on the rear side 66 of the front shield 14. The tabs 96 extending outwardly from the optic block 24 are inserted through the holes 76 in the rearwardly directed tabs 74 of the front shield 14.

A second subassembly 182 (FIG. 5), including the heat sink 26 and edge lit PCB 120, is assembled. To assemble the second subassembly 182, the gap filler 122 is adhered to the edge lit PCB 120. The adhesion may include coating one side of the gap filler 122 with adhesive and then applying the gap filler 122 to the edge lit PCB 120 so that it does not interfere with the operable side of the edge lit PCB 120. The gap filler 122 and edge lit PCB 120 are then inserted into the opening in the channel 116 on the front side 112 of the heat sink 26. Locating features are optionally provided on the heat sink 26, the edge lit PCB 120 or both, to aid in inserting the side lit PCB and gap filler 122 into the channel 116. The second subassembly 182 is placed in position on the rear side 92 of the optic block 24. The screw-receiving elements 98 extending rearwardly from the optic block 24 extend through the holes 130 in the heat sink 26.

The primary PCB 28 is placed above the top edge of the second subassembly 182, with the front side 140 facing upwards. The flexible electrical connector 80 from the display 22 is mated with the electrical connector therefor. The primary PCB 28 is then rotated 180 degrees about the top edge of the second subassembly 182, so that the front side 140 is in contact with the heat sink 26. When rotating the primary PCB 28, the flexible electric connector is wrapped over the top edge of at least a portion of the display module 18. The element wires are electrically connected with the electrical connectors therefor, and the wiring harness for the edge lit PCB 120 is connected with the electrical connector therefor.

As shown in FIGS. 4 and 5, the rear shield 16 is placed over the primary PCB 28, and the tabs 128 extending upwardly from the heat sink 26 are engaged with the slots 166 on the peripheral wall 164 of the rear shield 16. At least one screw 100 is inserted through the screw holes 168 in the rear shield 16, through the side cutouts 150 in the PCB, through the heat sink 26, and into the screw-receiving elements 98 on the optic block 24. It is desirable that two to three screws 100 are affixed in this manner. Heat stakes or other mechanical fastening devices could be used to subassembly together.

The forwardly directed cavity 170 of the rear housing 30 is placed over the rear shield 16, and the mechanically engaging features 172 of the rear housing 30 are snap fit to engage with the corresponding engagement feature 174 of the heat sink 26. The mounting member 32 may be installed in the rear housing 30 prior to assembly. It will be understood that the mounting member 32 may include a ball mount among other known constructions.

The present disclosure may be used with a mounting system such as that described in U.S. Pat. Nos. 8,814,373; 8,201,800; 8,210,695, 9,174,577; 8,925,891; 9,838,653; 8,960,629; 9,244,249; and U.S. Provisional Patent Application No. 61/704,869, which are hereby incorporated herein by reference in their entirety. Further, the present disclosure may be used with a rearview packaging assembly such as that described in U.S. Pat. Nos. 8,814,373; 8,646,924; 8,643,931; 8,264,761; 8,885,240; and 9,056,584; and U.S. Provisional Patent Application No. 61/707,625, which are hereby incorporated herein by reference in their entirety. Additionally, it is contemplated that the present disclosure can include a bezel such as that described in U.S. Pat. Nos. 8,827,517; 8,210,695; and 8,201,800, which are hereby incorporated herein by reference in their entirety.

The display mirror assembly according to the present disclosure has several advantages. The display module is supported by the front shield and rear shield and does not require a separate support or carrier plate. Omission of a carrier plate, and inclusion of retaining features in the front shield and rear shield, permits the display mirror assembly to be lighter, involve less parts for manufacturing, and to have a display which is viewable over a larger percentage of the total viewing area of the display mirror assembly.

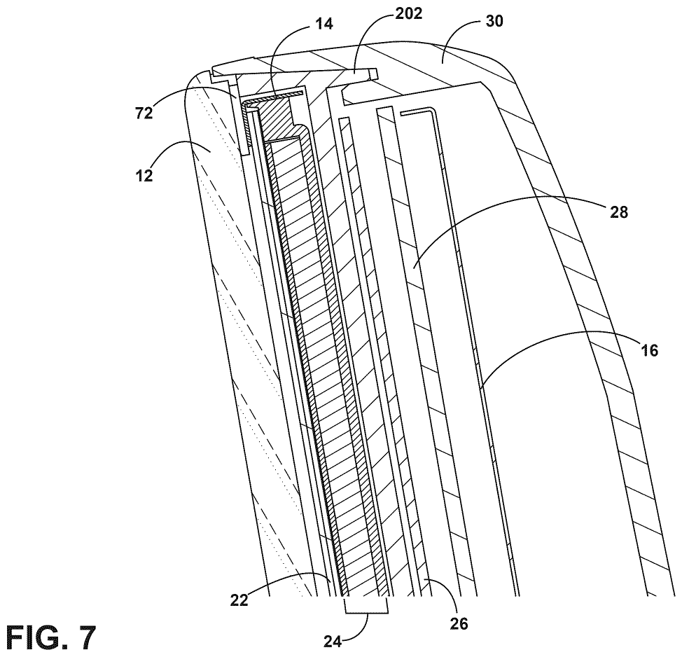

As shown in FIGS. 7-9, the display mirror assembly 10 can include one or more of the elements of FIGS. 1-6, and the housing 30 can be modified to be part of the partially reflective, partially transmissive element 12. Referring now to FIG. 7, a cross-sectional view of a display mirror assembly includes a partially reflective, partially transmissive element 12, a display 22, an optic block 24, a heat sink 26, and a primary PCB 28. A housing 30 can at least partially receive the front shield 14, the display module 18, and the rear shield 16. An adhesive, such as but not limited to, a foam adhesive 72, may also be used to secure the glass element 12 to the front shield 14. The display module 18 and optic block 24 can be supported by a carrier or support plate 202 rather than only the front shield 14 and rear shield 16. The wall stock thickness of the carrier or support plate 202 can be approximately 1.5 mm, or alternatively, have a thickness anywhere from 1.0 mm to 2.0 mm, which can enhance the amount of viewable area of the display module 18 while maintaining adequate support for the display mirror assembly 10.

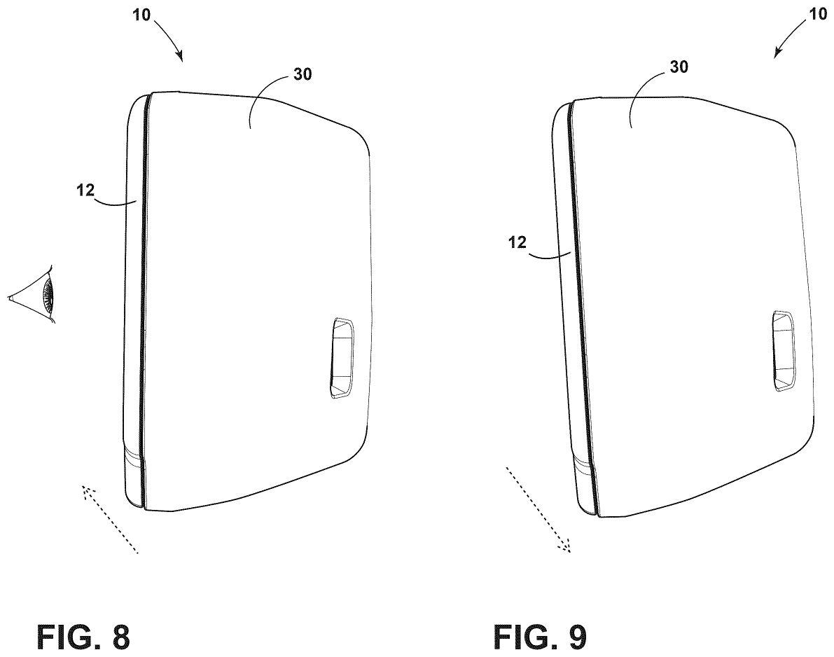

Additionally, or alternatively, as shown in FIGS. 8-11, the display mirror assembly 10 can include a sensor 400 operably coupled with an internal rear support 34 of the display mirror assembly 10. The sensor 400 is configured to detect changes in the angular position of the display mirror assembly 10. It is generally contemplated that the sensor 400 may be an accelerometer, gyroscope, magnetometer, etc. positioned within the housing 30 of the display mirror assembly 10. However, it is also contemplated that the sensor 400 may be positioned outside the housing 30. In some instances, it is contemplated that a sensor, such as the sensor 400, may be positioned proximate the mounting member 32 of the housing 30. In this instance, the sensor 400 may measure a total rotation of the housing 30 relative to the mounting member 32. The rotation of the housing 30 is done manually by a user when the user grasps the housing 30 by hand and rotates the housing 30 upward or downward about a horizonal axis.

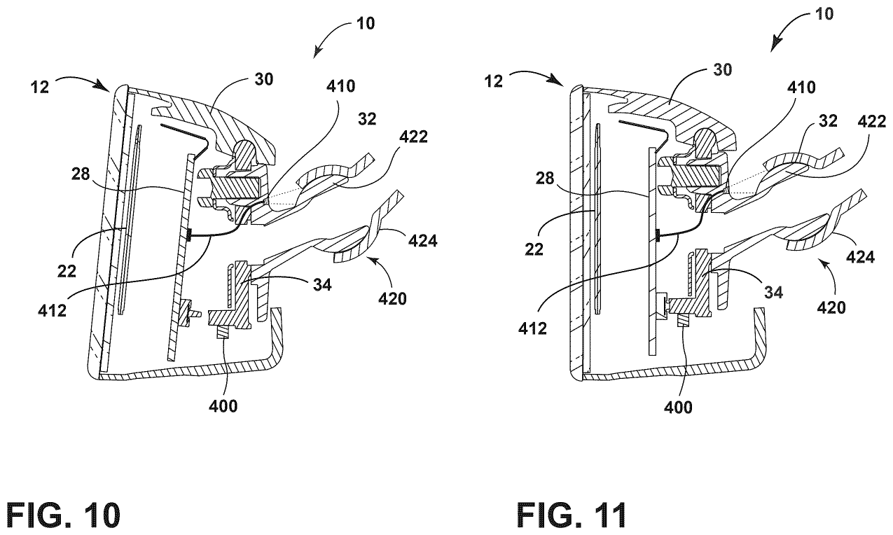

With reference to again to FIGS. 8 and 10, in the illustrated position, the display module 18 is active and a representation of image data collected from the imager is provided on the display 22. The display module 18 will continue to be active during use. In the event that a user desires to deactivate the display module 18 and rely on the reflective qualities associated with the glass element 12, this user simply manually rotates the housing 30 of the display mirror assembly 10 downward to a predefined degree. It is contemplated that rotation of the housing 30 between 2 and 7 degrees may be sufficient to deactivate the display module 18. In FIG. 8, the display module 18 is actively displaying image data captured from the imager. As shown the housing 30, and consequently, the display mirror assembly 10 is positioned so that the display 22 is generally perpendicular to the eyes of the user. When the user grasps the housing 30 and rotates the housing 30, and consequently the display 22, downward, the sensor 400 detects the rotation and when the housing 30 has rotated a threshold distance (FIG. 9), the display 22 deactivates and image data is no longer provided. The user is then free to use the reflective capacity of the glass element 12 to view scenery behind the vehicle. In FIG. 10, the housing 30 is tilted slightly upward when the display 22 is displaying image data. In this instance, rotation downward a threshold amount or to a preferred angular position deactivates the display 22 and a user can use the reflective qualities of the glass element 12 to view rearward of the vehicle (FIG. 11). It will be understood that the display mirror assembly 10 set forth herein may be configured to activate upon upward rotation of the housing 30 and consequently, the display 22 approximately 2 degrees to 7 degrees. However, it is also contemplated that the display mirror assembly 10 may be calibrated to activate the display upon downward rotation of the housing 30 and consequently, the display 22 approximately 2 degrees to 7 degrees. Further, activation of the display 22 may be set based on user preference. More specifically, the display module 18 may be calibrated by a user to activate the display 22 when the housing 30 has been rotated, a sufficient distance, upward or downward based on the predetermined user preference.

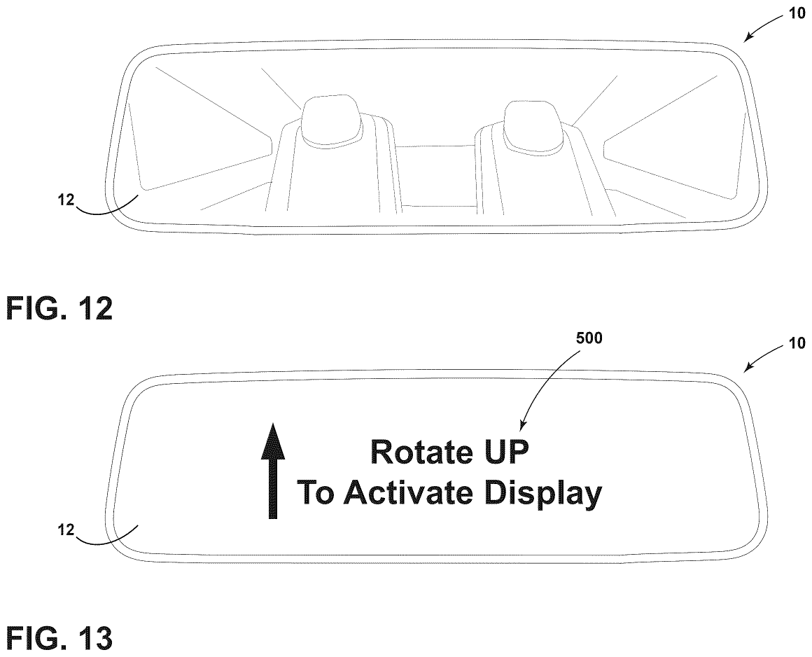

With reference now to FIGS. 11 and 12, when the display mirror assembly 10 is in the raised position, a display of rearward scenery outside of the vehicle is shown under the display module. In the event the user rotates the housing 30 of the display mirror assembly 10 downward, the display 22 is deactivated and the reflective properties of the glass element 12 maybe utilized by the user. In the event the user wishes to again activate the display 22, the user can manually rotate the housing 30 of the display mirror assembly 10 upward. Should the user not rotate the display mirror assembly 10 to a sufficient degree, a message 500 will be shown on the display 22 (FIG. 13), indicating that the display 22 will not be activated until the housing 30 has been sufficiently rotated upward. The display 22 will not be shown unless one or more sensors 400 of the display mirror assembly 10 detect movement of the housing 30. The movement may be in the form of adjustment to the mounting member 32, such as adjustment of the ball relative to the ball mount or may be detection of the relative angle of the housing 30 by the sensor 400.

With reference again to FIGS. 10 and 11, the sensor 400 may be disposed within the housing 30 at a lower portion thereof. Upon sufficient rotational movement of the housing 30 relative to the mounting member 32, the display 22 will activate or deactivate. In one configuration, a control circuit monitors data provided by the sensor 400. The sensor 400 provides real time data related to the relative orientation of the housing 30, and consequently, the display module 18 and display 22. Upon meeting a threshold requirement associated with a position of the display 22 relative to the eyes of a user, the display 22 will activate. Likewise, rotation in an opposite direction to a threshold requirement will result in deactivation of the display 22. Additionally, or alternatively, an image sensor 410 may be disposed at a rear portion of the display mirror assembly 10. The image sensor 410 is in communication with the PCB 28 via a data line 412. The image sensor 410 may be configured to capture image data related to the relative position of a ball mount 420 of the mounting member 32. It will be understood that one of a ball 422 and a socket 424 may be disposed on a rear wall of the housing 30 and at the same time, the other of a ball and a socket will extend from the windshield of a vehicle. As the ball 422 moves within the socket 424, image data is collected, and when the ball 422 has moved a sufficient degree within the socket 424, the display 22 will be activated or deactivated. In one instance, for example, as shown in FIGS. 10 and 11, when the housing 30 is in a raised position (FIG. 10) the display 22 is actively operating. Upon rotation of the housing 30, more of the ball 422 is exposed and no longer hidden within the socket 424. When a sufficient amount of the ball 422 is exposed, the display 22 deactivates. It will be understood that this operation could also work in reverse.

With reference now to FIGS. 12 and 13, the display mirror assembly 10 may include the message 500 that is shown on the display 22. The message 500 may be provided to relay a relative position of the display module 18 relative to the mounting member 32 or the angular position of the display module 18. For example, upon activation of the vehicle and consequently the display module 18 of the display mirror assembly 10, the display 22 may show image data captured by the imager (FIG. 12). In this way, the user knows that image data will be provided and the user will not be relying on the reflective qualities of the glass element 12. Alternatively, the display 22 may indicate to the user that the display mirror assembly 10 is in a reflective position so that a rear view of the scenery outside the vehicle is provided by the reflective qualities of the glass element 12. For example, as shown in FIG. 13, if the display module 18 is not at a sufficient angle to display image data from the image, the message 500 provided may state “ROTATE UP TO ACTIVATE DISPLAY.” However, the message 500 may also provide other more specific instructions to the user, such as “ROTATE AN ADDITIONAL 2 DEGREES TO ACTIVATE DISPLAY” or “ROTATE UPWARD JUST A LITTLE MORE.” The messages provided herein are illustrative only. It is contemplated the other messages consistent with the information intended to be relayed to the user related to the angular position of the display mirror assembly 10 can also be provided.

It will be understood by one having ordinary skill in the art that construction of the described disclosure and other components is not limited to any specific material. Other exemplary embodiments of the disclosure disclosed herein may be formed from a wide variety of materials, unless described otherwise herein.

According to another aspect of the present disclosure, a display mirror assembly for a vehicle includes an electro-optic element that includes a partially reflective, partially transmissive front substrate that has a rounded peripheral edge. The front substrate defines a first surface and a second surface. The electro-optic element also includes a rear substrate that defines a third surface and a fourth surface and an electro-optic medium disposed between the front substrate and the rear substrate. A mounting member is operably coupled to the vehicle and to the electro-optic element. An imager is configured to capture image data outside the vehicle. A display module is disposed adjacent to the rear substrate and configured to display the image data captured by the imager. A control circuit is configured to control and power the electro-optic element and the display module. A sensor is operably coupled with the electro-optic element and configured to monitor rotation of the electro-optic element between on-axis and off-axis positions and also activate or deactivate the display module.

According to another aspect of the present disclosure, a display module is configured to display messaging that relays a relative position of the display module relative to a mounting member.

According to still another aspect of the present disclosure, a control circuit activates a display module based on output from a sensor.

According to another aspect of the present disclosure, a sensor is an accelerometer.

According to yet another aspect of the present disclosure, when a sensor has detected a rotation between 2 degrees and 7 degrees downward, a control circuit deactivates a display module.

According to another aspect of the present disclosure, when a sensor has detected a rotation between 2 degrees and 7 degrees upward, a control circuit activates a display module.

According to still another aspect of the present disclosure, a mounting member includes a ball mount disposed adjacent a rear substrate.

According to another aspect of the present disclosure, a display mirror assembly for a vehicle includes a housing that is free of an axis-changing toggle flipper and an electro-optic element that is operable between a cleared state and a darkened state. The electro-optic element is supported within the housing. A display proximate the electro-optic element is at least partially visible through the electro-optic element. The housing is rotatable by a user to an off-axis position which changes an activation state of the display. The housing is also rotatable by the user to an on-axis position which also changes the activation state of the display.

According to another aspect of the present disclosure, a display includes one of a liquid crystal display (LCD), a light-emitting diode (LED), an organic light-emitting diode (OLED), a plasma, and a digital light processing (DLP) display element.

According to still another aspect of the present disclosure, an outer perimeter of an electro-optic element is frameless.

According to yet another aspect of the present disclosure, a display is in electrical communication with an imager that is disposed on a rear portion of a vehicle.

According to still yet another aspect of the present disclosure, rotation of a housing about a horizontal axis between 2 degrees and 7 degrees changes an activation state of a display.

According to another aspect of the present disclosure, a display mirror assembly for a vehicle includes an electro-optic element and a mounting member that is operably coupled to the vehicle and to the electro-optic element. An imager is configured to capture image data outside the vehicle. A signal representative of received light is communicated from the imager to a control circuit and the image data captured by the imager is evaluated by the control circuit to determine likely glare on the electro-optic element. A display module is disposed adjacent to a rear substrate and is configured to display the image data captured by the imager. The control circuit is configured to control and power the electro-optic element and the display module. A sensor is operably coupled with the electro-optic element. The control circuit is configured to monitor vertical rotation of the electro-optic element between an on-axis position where the display module is activated and an off-axis position where the display module is deactivated.

According to still another aspect of the present disclosure, a display module is configured to display messaging relaying a position of the display module relative to a mounting member.

According to another aspect of the present disclosure, a control circuit is configured to display messaging relaying a position of a display module only when an electro-optic element is rotating vertically.

According to yet another aspect of the present disclosure, a control circuit includes functionality to disable activation and deactivation of a display module.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A display mirror assembly for a vehicle, the display mirror assembly comprising:
an electro-optic element including:
a partially reflective, partially transmissive front substrate having a rounded peripheral edge, the front substrate defining a first surface and a second surface;
a rear substrate defining a third surface and a fourth surface; and
an electro-optic medium disposed between the front substrate and the rear substrate;
a mounting member operably coupled to said vehicle and to the electro-optic element;
an imager configured to capture image data outside said vehicle;
a display module disposed adjacent to the rear substrate, the display module configured to display the image data captured by the imager, wherein a control circuit is configured to control and power the electro-optic element and the display module; and
a sensor operably coupled with the electro-optic element and configured to monitor rotation of the electro-optic element between on-axis and off-axis positions and also activate or deactivate the display module.

2. The display mirror assembly of claim 1, wherein the display module is configured to display messaging relaying a position of the display module relative to the mounting member.

3. The display mirror assembly of claim 1, wherein the control circuit activates the display module based on output from the sensor.

4. The display mirror assembly of claim 1, wherein the sensor is an accelerometer.

5. The display mirror assembly of claim 1, wherein when the sensor has detected a rotation between 2 degrees and 7 degrees downward, the control circuit deactivates the display module.

6. The display mirror assembly of claim 1, wherein when the sensor has detected a rotation between 2 degrees and 7 degrees upward, the control circuit activates the display module.

7. The display mirror assembly of claim 1, wherein the mounting member includes a ball mount disposed adjacent the rear substrate.

8. A display mirror assembly for a vehicle, comprising:
a housing that is free of an axis-changing toggle flipper;
an electro-optic element operable between a cleared state and a darkened state, the electro-optic element supported within the housing; and
a display proximate the electro-optic element and at least partially visible through the electro-optic element, wherein the housing is rotatable by a user to an off-axis position which changes an activation state of the display, and wherein the housing is also rotatable by the user to an on-axis position which also changes the activation state of the display.

9. The display mirror assembly of claim 8, wherein the display includes one of a liquid crystal display (LCD), a light-emitting diode (LED), an organic light-emitting diode (OLED), a plasma, and a digital light processing (DLP) display element.

10. The display mirror assembly of claim 8, wherein an outer perimeter of the electro-optic element is frameless.

11. The display mirror assembly of claim 8, wherein the display is in electrical communication with an imager that is disposed on a rear portion of said vehicle.

12. The display mirror assembly of claim 8, wherein rotation of the housing about a horizontal axis between 2 degrees and 7 degrees changes the activation state of the display.

13. A display mirror assembly for a vehicle, the display mirror assembly comprising:
an electro-optic element;
a mounting member operably coupled to said vehicle and to the electro-optic element;
an imager configured to capture image data outside said vehicle, wherein a signal representative of received light is communicated from the imager to a control circuit, and wherein the image data captured by the imager is evaluated by the control circuit to determine likely glare on the electro-optic element;
a display module disposed adjacent to a rear substrate, the display module configured to display the image data captured by the imager, wherein the control circuit is configured to control and power the electro-optic element and the display module; and
a sensor operably coupled with the electro-optic element, wherein the control circuit is configured to monitor vertical rotation of the electro-optic element between an on-axis position where the display module is activated and an off-axis position where the display module is deactivated.

14. The display mirror assembly of claim 13, wherein the display module is configured to display messaging relaying a position of the display module relative to the mounting member.

15. The display mirror assembly of claim 14, wherein the control circuit is configured to display messaging relaying the position of the display module only when the electro-optic element is rotating vertically.

16. The display mirror assembly of claim 13, wherein the display module is in electrical communication with an imager that is disposed on a rear portion of said vehicle.

17. The display mirror assembly of claim 13, wherein rotation of the electro-optic element about a horizontal axis between 2 degrees and 7 degrees changes an activation state of the display module.

18. The display mirror assembly of claim 13, wherein the control circuit includes functionality to disable activation and deactivation of the display module.

19. The display mirror assembly of claim 13, wherein the display module includes one of a liquid crystal display (LCD), a light-emitting diode (LED), an organic light-emitting diode (OLED), a plasma, and a digital light processing (DLP) display element.

20. The display mirror assembly of claim 13, wherein an outer perimeter of the electro-optic element is frameless.
